(19) United States
(12) Patent Application Publication
(10) Pub. No.: US 2007/0177748 A1
(43) Pub. Date: Aug. 2, 2007

(54) Earphone structure

(75) Inventor: Jen-Han Yang, Taipei City (TW)

Correspondence Address: BRUCE H. TROXELL, SUITE 1404, 5205 LEEBURG PIKE, FALLS CHURCH, VA, 22041, US

(73) Assignees: IATEC LIMITED; Yi-Rong CHEN; Jen-Han YANG

(21) Appl. No.: 11/430,921

(22) Filed: May 10, 2006

(30) Foreign Application Priority Data
Jan. 27, 2006 (TW) 095202097

(51) Int. Cl. H04R 25/00; H04R 5/02

(52) U.S. Cl. 381/309; 381/371; 381/374

(57) ABSTRACT

An earphone structure comprises a housing body and a cover body combined therewith. A first speaker, a second speaker and a hood body are respectively combined to the inside and the outside of said cover body. The central axes of the first speaker and the second speaker are respectively pointed to a direction in which the lower end of the hood body is corresponding to an earhole of a user's ear. Whereby, when the user wears the earphone, the user's earhole can receive the largest amplitude of sound wave emitted from each speaker so as to obtain the best stereo sound effect.

### BACKGROUND OF THE INVENTION

1. Field of the Invention

The present invention relates to an earphone, and more particularly to a multi-channels earphone structure allowing the earphone to have a better stereo sound effect.

2. Description of Related Art

For allowing an earphone to have a better sound effect, many inventions concerning the earphone have been proposed, for example, Taiwan patent No. 534,556, Taiwan utility patent Nos. 248,180 and 271,332.

Among these, Taiwan utility patent No. 248,180 discloses an earphone structure, comprising a housing body, a cover body, at least three speakers and a hood body. The cover is a frame body combined with an arc cover to form a space combining the speakers and the cover body. The cover body has three combining grooves respectively combined with one speaker. The central axes of the openings of three connecting grooves are formed in three different directions to constitute a structure with three channels and three directions. Therefore, it has a better stereo sound effect and bass effect.

When an earhole of a human's ear aligns with a direction of the sound emitted from a speaker, it can receive the largest amplitude of sound wave; and when the earhole does not align with the direction of the sound emitted from the speaker, the amplitude of the received sound wave is smaller; the sound effect is worse. The Taiwan patent mentioned above is to allow the three speakers in the earphone to be pointed to three directions respectively, and not to be pointed commonly to the direction of an earhole of a user; this will cause the sound emitted from three speakers not to attain to the best stereo sound effect.

### SUMMARY OF THE INVENTION

For allowing a plurality of speakers in an earphone to generate the best stereo sound effect, the present invention is proposed.

The main object of the present invention is to provide an earphone structure, allowing an earphone to have a better stereo sound effect.

For attaining to the object mentioned above, the present invention proposes an earphone structure comprises a housing body and cover body combined therewith. A first speaker, a second speaker and a hood body are respectively combined to the inside and the outside of the cover body. It is characterized in that the central axes of the first and the second speakers are respectively pointed to a direction in which the lower end of the hood body is corresponding to the earhole of a user's ear worn with the earphone. Whereby, when the user wears the earphone, the earhole of the user can receive the largest amplitude of the sound wave emitted from each speaker so as to obtain the best stereo sound effect.

### BRIEF DESCRIPTION OF THE DRAWINGS

The present invention can be more fully understood by reference to the following description and accompanying drawings, in which:

FIGS. 1 is a prospective view, showing a whole set of earphone of the present invention;

FIG. 2 is an exploded view, showing a cover body and a two speakers combined therewith of an earphone of the present invention; and

FIG. 3 is a schematic view, showing that the central axes of two speakers of an earphone of the present invention are pointed to the earhole of a user's ear.

### DETAILED DESCRIPTION OF THE PREFERRED EMBODIMENTS

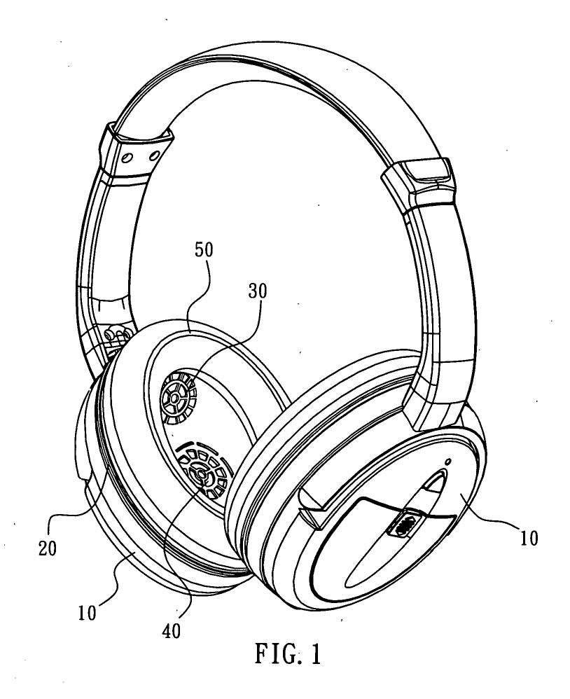

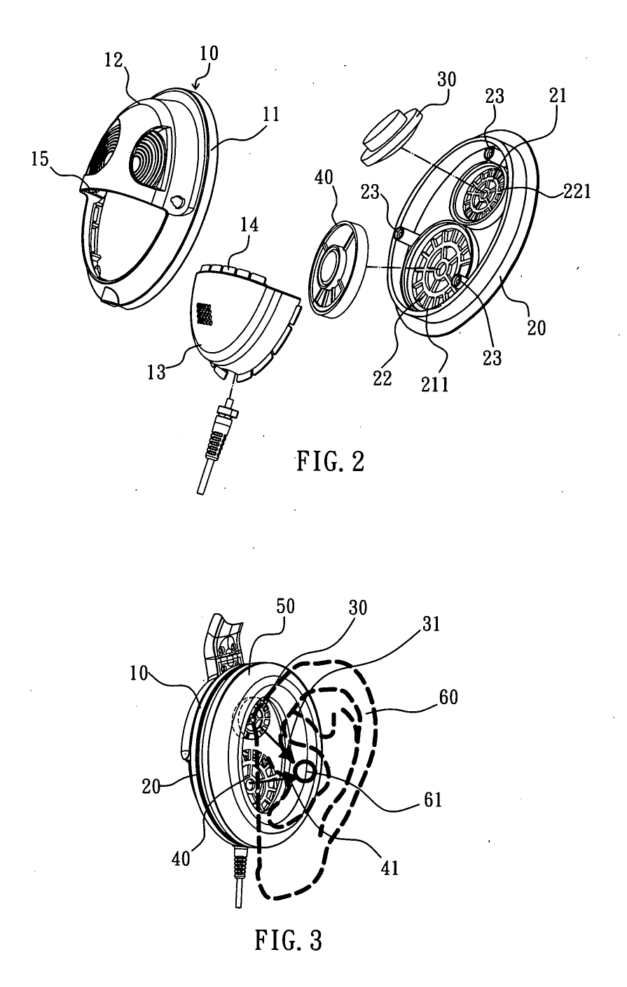

Please refer to FIGS. 1 and 2. An earphone mainly comprises a housing body 10 and a cover body 20 combined therewith; a first speaker 30, second speaker 40 and hood body 50 are respectively combined to the inside and the inside of the cover body 20.

Please refer to FIGS. 2 and 3. The housing body 10 is constituted by combining a circular frame 11 with an arc cover to form a space for installing the speakers 30 and 40 and the cover body 20. Combining two half-arc covers 12 and 13 together forms the arc cover. Here, the half-arc cover 12 is combined with the circular frame 11, the half-arc cover 13 and the half-arc cover 12 are detachably combined with each other, tenons 14 at the side of the half-arc cover 13 is engaged with corresponding grooves 15 of the half-arc cover 12 to cause the both to be combined together.

The cover body 20 has an integrated first combining groove 21 and second combining groove 22. The first combining groove 21 and the second combining groove 22 are respectively combined with the first speaker 30 and the second speaker 40. The central axes of the openings of the first combining groove 21 and the second combining groove 22 are respectively pointed to a direction in which the lower end of the hood body 50 is corresponding to a earhole 61 of a human's ear 60 to cause the central axes 31 and 41 of the first speaker 30 and the second speaker 40 to be pointed to a direction in which the lower end of the hood body 50 is corresponding to the earhole 61 of the ear 60 as FIG. 3 shows. A plurality of through holes 211 and 221 are respectively disposed at the front ends of the first combining groove 21 and the second combining groove 22, they are used for allowing the sound waves emitted from the first speaker 30 and the second speaker 40 to be penetrated out. A several screw holes 23 disposed on the cover body 20 are used for screws to lock the cover body 20 to the corresponding screw holes disposed on the housing body 10.

Please refer to FIG. 3. The second speaker 40 can be a heavy bass speaker positioned at the lower end of the cover body corresponding to the front of the human's earhole 61, the central axis 41 thereof is pointed to a horizontal direction. Furthermore, the first speaker 30 can be an alt speaker positioned at the upper side of the second speaker 40. The central axis 31 of the first speaker 30 is inclined downward approximately in the range of 5 to 55 degrees from a horizontal direction; the central axis 31 is pointed to a direction in which the lower end of the hood body 50 is corresponding to the human's earhole 61 to allow the earphone to perform the best stereo sound effect.

According to the present invention, the design allowing the central axes of speakers in an earphone to point to the earhole of a human's ear enables the earhole of the user to receive the largest amplitude of sound wave emitted from each speaker to obtain the best stereo sound effect when the user wears an earphone.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An earphone structure, comprising a housing body and a cover body combined therewith; a first speaker, a second speaker and a hood body being respectively combined to the inside and the outside of said cover body; the central axes of said first speaker and said second speaker being respectively pointed to a direction in which the lower end of said hook body is corresponding to an earhole of a human's ear worn with an earphone; whereby, when a user wears said earphone, said user's earphone can receive the largest amplitude of sound wave emitted from each speaker so as to obtain the best stereo sound effect.

2. The earphone structure according to claim 1, wherein said second speaker is positioned at the lower end of said cover body corresponding to the front of said earhole of said user's ear worn with said earphone, the central axis of said second speaker is pointed to a horizontal direction.

3. The earphone structure according to claim 2, wherein said first speaker is positioned at the upper side of said second speaker; the central axis of said speaker is inclined downward an angle between 5 and 55 degrees from a horizontal direction.

4. The earphone structure according to claim 3, wherein said first speaker is an alt speaker; said second speaker is heavy bass speaker.

5. The earphone structure according to claim 4, wherein said cover body has a first combining groove and a second combining groove; said first combining groove and said second combining groove are respectively combined with said first speaker and said second speaker.

6. The earphone structure according to claim 5, wherein said housing body comprises a circular frame and an arc cover combined therewith to form a space for combining said first speaker, said second speaker and said cover body together.

7. The earphone structure according to claim 6, wherein said arc cover is formed by combining two half-arc covers; one of said half-arc covers is combined with said circular frame, said half-arc cover is detachably combined with another half-arc cover.

8. The earphone structure according to claim 7, wherein said two half-arc covers respectively have corresponding tenons and engaging grooves, said tenons and said engaging grooves are engaged.
